(19) United States
(12) Patent Application Publication
(10) Pub. No.: US 2008/0115667 A1
(43) Pub. Date: May 22, 2008

(54) Conductive membrane for carbon dioxide separation

(75) Inventors: Shiwoo Lee, Daejeon (KR); Sang Kuk Woo, Daejeon (KR); Ji Haeng Yu, Daejeon (KR); Doo Won Seo, Daejeon (KR); Ki suk Hong, Daejeon (KR); In Sub Han, Daejeon (KR); Se Young Kim, Gyeonggi-do (KR)

Correspondence Address: STEPTOE & JOHNSON LLP, 1330 CONNECTICUT AVENUE, N.W., WASHINGTON, DC, 20036, US

(73) Assignee: Korea Institute of Energy Research, Daejeon (KR)

(21) Appl. No.: 11/984,736

(22) Filed: Nov. 21, 2007

(30) Foreign Application Priority Data
Nov. 21, 2006 (KR) 10-2006-0114880

(51) Int. Cl. B01D 53/22; B05D 3/02; B01D 67/00

(52) U.S. Cl. 95/51; 427/372.2; 96/5

(57) ABSTRACT

Disclosed are a conductive membrane able to selectively separate carbon dioxide from a gas mixture containing carbon dioxide, a manufacturing method thereof, and a method of separating carbon dioxide using the membrane. The conductive membrane for carbon dioxide separation includes molten carbonate, acting as a carbonate-ion conductor, and oxide, acting as an electronic conductor, and has infinite selectivity for carbon dioxide at high temperatures of 500° C. or more.

### BACKGROUND OF THE INVENTION

1. Field of the Invention

The present invention relates to a conductive membrane that is able to selectively separate only carbon dioxide from a gas mixture containing carbon dioxide, to a method of manufacturing the same, and to a method of separating carbon dioxide using the membrane. According to the present invention, the conductive membrane for carbon dioxide separation includes molten carbonate, acting as a carbonate-ion conductor, and oxide, acting as an electron conductor, and has infinite selectivity for carbon dioxide at high temperatures of 500° C. or more.

2. Description of the Related Art

The ambient concentration of carbon dioxide, which is one of the main causes of global warming, is increasing at a rate of 1 or more ppm every year, attributable to the consumption of fossil fuels, and thus, techniques for the effective treatment thereof are regarded as very important in the interest of energy resources and the environment. Such techniques for recovering carbon dioxide include absorption methods and adsorption methods, which have reached the stage of practical usefulness. Further, in the recovery of carbon dioxide from a great amount of exhaust gas, drastic reduction of energy consumption is required, but is presently difficult to technically implement.

The gas separation process using a membrane enables low energy consumption and the simplification of equipment and operation, and is thus suitable for use as a technique for separating large amounts of carbon dioxide. Materials for such a membrane include, for example, polymers, metals, and ceramics. In particular, a ceramic membrane has superior heat resistance and chemical resistance.

A conventional ceramic membrane for the separation of carbon dioxide has been studied in the form of a porous membrane using a porous structure. However, this membrane is disadvantageous because selectivity for carbon dioxide is significantly decreased under conditions of temperature of 100° C. or higher, and the function as a membrane is lost, and it entails undesirable problems related to the process in which high-temperature combustion exhaust gas, which is a main carbon dioxide source, should be cooled to about room temperature to separate carbon dioxide therefrom.

With the aim of separating carbon dioxide from a gas mixture at high temperatures of 500° C. or more, the case where molten carbonate, electrodes and external circuits are used has been reported [K. Sugiura et. al., Journal of Power Sources 118 (2003) 218-227]. In this case using the reverse reaction of a molten carbonate fuel cell, however, there are difficulties in constructing the apparatus, in which electrical power should be supplied from the outside through lead wires connected to opposite electrodes of the molten carbonate electrolyte.

### SUMMARY OF THE INVENTION

Accordingly, the present invention has been made keeping in mind the above problems occurring in the related art, and an object of the present invention is to provide a conductive membrane for carbon dioxide separation, which is operated using carbonate, which is conductive to a carbonate ion, and oxide, which is electronically conductive, without the need to supply electrical power from the outside, in order to selectively separate carbon dioxide from a gas mixture, such as combustion exhaust gas, at high temperatures of 500° C. or more.

Another object of the present invention is to provide a method of manufacturing the membrane and a method of separating carbon dioxide using the membrane.

In order to accomplish the above objects, the present invention provides a conductive membrane for carbon dioxide separation, including a porous electronically conductive oxide structure, the porous portion of which is filled with molten carbonate.

The conductive membrane of the present invention may further include a molecule-ion exchange catalyst applied on the surface of the structure.

In addition, the present invention provides a method of manufacturing a conductive membrane for carbon dioxide separation, including applying carbonate on the surface of a porous electronically conductive oxide structure, thus forming a laminate, and heating the laminate to a temperature equal to or higher than the melting temperature of the carbonate, thus melting the carbonate in order for molten carbonate to infiltrate the pores of the electronically conductive oxide.

The method of the present invention may further include applying a molecule-ion exchange catalyst on the outer surface of the carbonate, after applying the carbonate on the surface of the porous electronically conductive oxide structure.

In addition, the present invention provides a method of separating carbon dioxide from a gas mixture, including defining an injection region and a permeation region at both sides of a conductive membrane for carbon dioxide separation using a sealing material and a container, injecting inert gas, hydrogen, or inert gas containing hydrogen into the permeation region or maintaining the permeation region in a vacuum state, injecting the gas mixture containing carbon dioxide into the injection region, and collecting the separated carbon dioxide from a surface opposite the surface of the conductive membrane for carbon dioxide separation where the carbon dioxide is injected.

### BRIEF DESCRIPTION OF THE DRAWINGS

FIG. 1 is a schematic view illustrating the apparatus for separating carbon dioxide using the reverse reaction of a molten carbonate fuel cell;

FIG. 2 is a schematic view illustrating the apparatus for separating carbon dioxide using a conductive membrane for carbon dioxide separation, according to the present invention;

FIG. 3 is a micrograph illustrating the electronically conductive oxide structure; and

FIG. 4 is a micrograph illustrating the conductive membrane for carbon dioxide separation, in which the electronically conductive oxide structure is impregnated with carbonate.

### DESCRIPTION OF THE PREFERRED EMBODIMENTS

According to the present invention, carbonate, composed of one to three types of carbonates, plays a role in a molten state as a carbonate-ion conductor. The molten state of the carbonate is maintained between 350° C. and 650° C., depending on the type and component fraction of mixed carbonate.

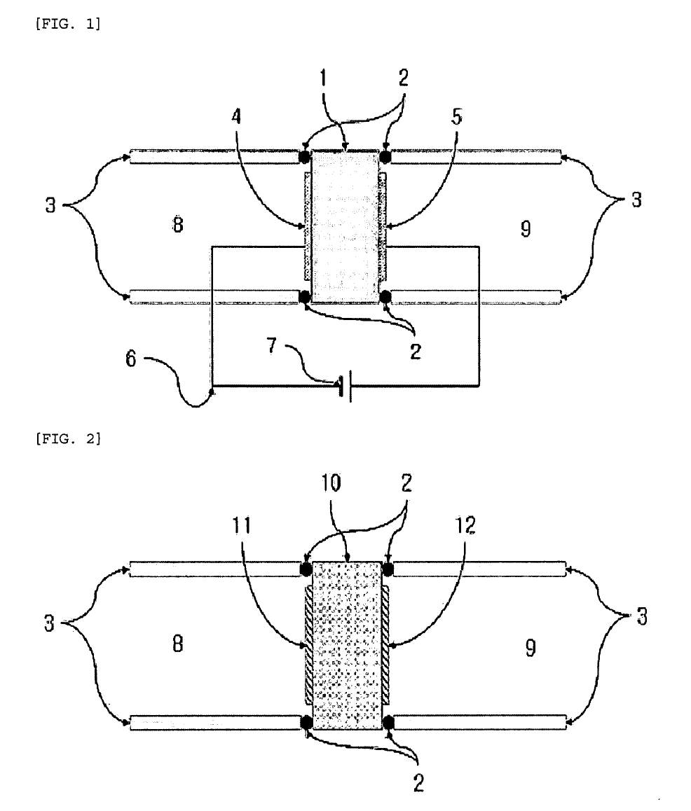

A conventional apparatus for separating carbon dioxide, in which an inert support is impregnated with a molten carbonate electrolyte, is schematically illustrated in FIG. 1. Both sides of the molten carbonate electrolyte 1 define an injection region 8 and a permeation region 9 using a high-temperature sealing material 2 and a container 3, and a cathode 4 and an anode 5 are provided at opposite surfaces of the electrolyte. Each electrode is connected to an external power source 7 through a lead wire 6.

In the case where a multi-type gas mixture containing carbon dioxide and oxygen is injected into the injection region 8, an electrochemical reaction occurring at the cathode 4 is represented by Reaction 1 below:

$$\frac{1}{2} {O}_{2} + {CO}_{2} + 2 {e}^{-} \to {CO}_{3}^{2 -} \qquad Reaction 1$$

On the other hand, an electrochemical reaction occurring at the anode 5 is represented by Reaction 2 below:

$${CO}_{3}^{2 -} \to \frac{1}{2} {O}_{2} + {CO}_{2} + 2 e \qquad Reaction 2$$

Thus, other gas components, such as nitrogen, cannot permeate through the membrane, and only oxygen and carbon dioxide can be transferred to the permeation region 9 through conduction.

In order to continuously transfer carbon dioxide, electrons produced on the surface of the membrane of the permeation region should be transferred to the surface of the membrane of the injection region. In the case where the external lead wire, which is difficult to use to construct the apparatus, is not used, the electronic conductor should essentially constitute part of the membrane. However, because the electronic conductor, such as metal or alloy, reacts with the molten carbonate to thus form oxide, resistance to electronic conductivity is drastically increased, making it unsuitable for use as the material for the membrane.

The membrane of the present invention, in which the above problems are solved, includes molten carbonate and oxide, which is chemically stable to molten carbonate and is electronically conductive. The electronically conductive oxide of the present invention may be oxide having a perovskite (ABO₃) structure or a pseudoperovskite structure.

The perovskite structure is an optical material represented by ABX₃, wherein A is a divalent or trivalent cationic metal, B is a trivalent or tetravalent cationic metal (typically, a transition metal), and X is a divalent gas anion, such as O or F.

Preferably, in the perovskite oxide having electronically conductive properties, the A-site cation is mainly based on La, some of which is substituted with Ca, Ba or Sr (0.1˜0.5 mol), and the B-site cation consists of a unary to ternary composition of Co, Fe, Ni, Cu, or Cr.

The membrane apparatus is schematically illustrated in FIG. 2. Both sides of the membrane 10, having carbonate and electronically conductive oxide, define the injection region 8 and the permeation region 9 using a high-temperature sealing material 2 and a container 3, and molecule-ion exchange catalysts 11, 12 are applied on opposite surfaces of the membrane.

The electrochemical reaction occurring at the surface of the membrane when a gas mixture containing carbon dioxide and oxygen is injected to the injection region 8, and the electrochemical reaction occurring at the surface of the membrane of the permeation region 9, are represented by Reactions 1 and 2.

The electronically conductive oxide should have a three-dimensionally connected structure in order to provide an electron transfer path in the membrane. The molten carbonate should have a three-dimensionally connected structure in order to provide a carbonate-ion transfer path in the membrane.

The membrane having the three-dimensionally connected structure may be obtained by producing a sintered product of electronically conductive oxide having a porosity of 20-50%, and preferably 30-40%.

The particle size, pore size and porosity of the electronically conductive oxide may be adjusted depending on the compacting pressure or the sintering temperature of the electronically conductive oxide. A pore-forming agent may be added, if necessary.

Further, carbonate is applied on the surface of the porous electronically conductive oxide structure, such that carbonate in a molten state infiltrates the pores of the electronically conductive oxide structure by capillary force. The molten carbonate of the present invention may be selected from among alkali metal carbonates and mixtures thereof.

Furthermore, a catalyst for facilitating the molecule-ion exchange on the surface of the membrane may be applied on the outer surface of the carbonate. The molecule-ion exchange catalyst may be selected from among transition metals, transition metal oxides, and precious metals.

When the structure in which the carbonate and the catalyst are sequentially laminated is heated to 500° C. or higher, the carbonate is melted and infiltrates the pores of the porous electronically conductive oxide structure by capillary force. In this case, in order to prevent the gas molecules other than carbon dioxide from leaking through the membrane, all pores of the porous electronically conductive oxide structure must be filled with the molten carbonate, so that these pores are not continuously connected.

Below, a method of manufacturing the membrane is described through the following example.

### Example 1

### Manufacture of Conductive Membrane

A sintered perovskite oxide product, in which a molar fraction of La, Sr and Co is 0.6, 0.4 and 1.0, was produced.

The power mixture, in which the molar fraction of La, Sr and Co is 0.6, 0.4 and 1.0, was maintained at 1000° C. for 2 hours or longer, thus forming a perovskite single phase, which was then compacted under pressure of 1 ton_{f} using a disc-shaped mold having a diameter of 21 mm, and then sintered at 1050° C., thereby producing a sintered product.

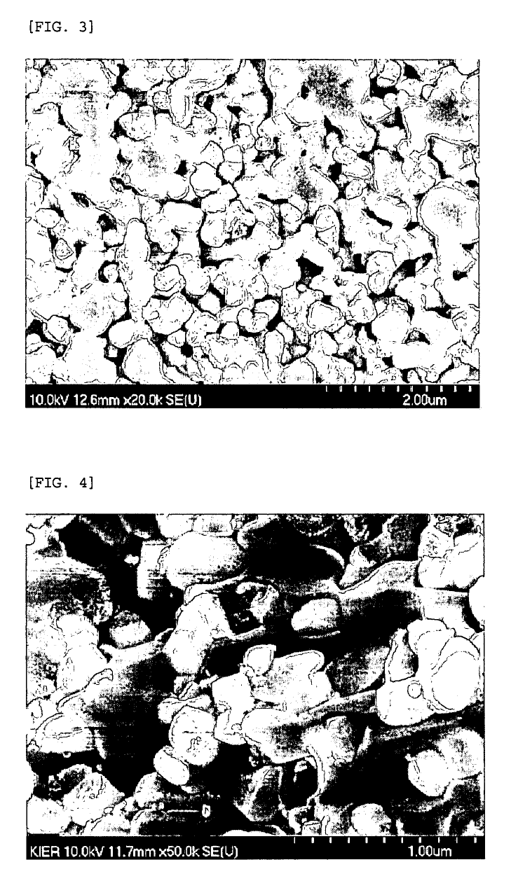

FIG. 3 is a micrograph illustrating the electronically conductive oxide structure produced through heat treatment at 1050° C.

A carbonate mixture composed of Li₂CO₃ and K₂CO₃ at a molar ratio of 62:38 was molded and then attached to the surface of the electronically conductive oxide structure. Further, a molecule-ion exchange catalyst was applied on the outer surface of the molded carbonate product and the outer surface of the electronically conductive oxide structure.

The laminate sample thus obtained was heated to 500° C. or higher, thus melting carbonate in order for molten carbonate to infiltrate the pores of the electronically conductive oxide structure.

FIG. 4 is a micrograph illustrating the membrane in which the electronically conductive oxide structure is impregnated with the carbonate. This membrane has a structure in which the carbonate infiltrates the porous portion of the electronically conductive oxide structure.

Below, a method of separating carbon dioxide using the membrane is described through the following example.

### Example 2

### Separation of Gas Mixture using Conductive Membrane

The conductive membrane manufactured in Example 1 was mounted between containers 3, as seen in FIG. 2, and an injection region 8 and a permeation region 9 were defined at both sides of the conductive membrane using a high-temperature sealing material 2. Carbon dioxide, oxygen and nitrogen were injected into the injection region, while inert gas, hydrogen or inert gas containing hydrogen was injected into the permeation region, or alternatively, the permeation region was maintained in a vacuum state, after which the membrane was maintained at 650° C.

The gases, which were separated through the conductive membrane and then discharged to the permeation region, were qualitatively and quantitatively analyzed using a gas analyzer, including gas chromatography. Among gases discharged from the permeation region, oxygen was condensed to water vapor through reaction with hydrogen, and only pure carbon dioxide was collected.

As the result of analysis of the gas component of the permeation region using gas chromatography, no nitrogen was detected, whereas carbon dioxide was detected at a rate of 0.1 or more cc per unit area (cm²).

As described hereinbefore, the present invention provides a conductive membrane for carbon dioxide separation. Using the conductive membrane for carbon dioxide separation according to the present invention, only carbon dioxide may be selectively separated from a gas mixture composed of carbon dioxide, oxygen and nitrogen, even at high temperatures. Further, the conductive membrane for carbon dioxide separation of the present invention is advantageous because it can efficiently separate carbon dioxide, thanks to its infinite selectivity for carbon dioxide at high temperatures, without the need to supply electrical power through external lead wires. Therefore, the conductive membrane for carbon dioxide separation of the present invention may be used in the field in which pure carbon dioxide is separated from a gas mixture, including high-temperature combustion exhaust gas.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A conductive membrane for carbon dioxide separation, comprising a porous electronically conductive oxide structure, a porous portion of which is filled with molten carbonate.

2. The conductive membrane as set forth in claim 1, further comprising a molecule-ion exchange catalyst applied on a surface of the structure.

3. The conductive membrane as set forth in claim 1 or 2, wherein the porous electronically conductive oxide is a perovskite oxide (ABX₃) having a substituted cation.

4. The conductive membrane as set forth in claim 3, wherein, in the perovskite oxide (ABX₃), A is an La cation, in which Ca, Ba or Sr is substituted at a molar fraction of 0.1˜0.5, and B is a unary to ternary cation of Co, Fe, Ni, Cu, or Cr.

5. The conductive membrane as set forth in claim 1 or 2, wherein the porous electronically conductive oxide has a porosity of 20˜50%.

6. The conductive membrane as set forth in claim 5, wherein the porous electronically conductive oxide has a porosity of 30˜40%.

7. The conductive membrane as set forth in claim 1 or 2, wherein the molten carbonate is selected from among alkali metal carbonates and mixtures thereof.

8. The conductive membrane as set forth in claim 1 or 2, wherein the molecule-ion exchange catalyst is selected from among transition metals, transition metal oxides, and precious metals.

9. A method of manufacturing a conductive membrane for carbon dioxide separation, comprising:
applying carbonate on a surface of a porous electronically conductive oxide structure, thus forming a laminate; and
heating the laminate to a temperature equal to or higher than a melting temperature of the carbonate, thus melting the carbonate in order for molten carbonate to infiltrate pores of the electronically conductive oxide.

10. The method as set forth in claim 9, further comprising applying a molecule-ion exchange catalyst on an outer surface of the carbonate, after applying the carbonate on the surface of the porous electronically conductive oxide structure.

11. A method of separating carbon dioxide from a gas mixture, comprising:
defining an injection region and a permeation region at two sides of a conductive membrane for carbon dioxide separation using a sealing material and a container;
injecting inert gas, hydrogen, or inert gas containing hydrogen into the permeation region, or maintaining the permeation region in a vacuum state;
injecting the gas mixture containing carbon dioxide into the injection region; and
collecting the separated carbon dioxide from a surface opposite the surface of the conductive membrane for carbon dioxide separation where the carbon dioxide is injected.
